(19) United States
(12) Patent Application Publication
(10) Pub. No.: US 2006/0225647 A1
(43) Pub. Date: Oct. 12, 2006

(54) Doctor blade holder

(76) Inventor: Robert A. Reid, Charlton City, MA (US)

Correspondence Address: GAUTHIER & CONNORS, LLP, 225 FRANKLIN STREET, BOSTON, MA, 02110, US

(21) Appl. No.: 11/101,349

(22) Filed: Apr. 7, 2005

(51) Int. Cl. B05C 1/08

(52) U.S. Cl. 118/261; 118/413

(57) ABSTRACT

A doctor blade holder has a top plate having a rear portion overlying a base structure and a front portion projecting forward from the base structure. Blade support members are carried by and cooperate with the front portion of the top plate to define forwardly open slots for receiving the doctor blade. A hinge is interposed between the rear portion of the doctor blade and the base structure. The hinge has a body portion defining a fulcrum about which the top plate pivots relative to the base structure, and has forwardly and rearwardly projecting integral flanges arranged respectively to underlie the top plate and overlie the base structure. The doctor blade holder has means for securing the forwardly projecting flanges to the top plate and for securing the rearwardly projecting flanges to the base structure.

### BACKGROUND

1. Field of the Invention

This invention relates generally to web processing machines, such as paper machines and the like, and is concerned in particular with an improved apparatus for doctoring the rolls of such machines.

2. Description of the Prior Art

In known doctoring arrangements of the type disclosed for example in U.S. Pat. No. 5,279,710 (Aikawa), U.S. Pat. No. 4,906,335 (Goodnow et al.), and U.S. Pat. No. 4,665,859 (Dunlap et al.), the doctor blades are carried by holders that are rotatable about pivot rods. Under certain operating conditions, these holders have a tendency to vibrate or chatter due to the clearances that must necessarily be introduced between the relatively rotatable components.

In other known doctoring arrangements of the type disclosed for example in U.S. Pat. No. 6,328,853 (Goodnow et al.), the doctor blades are carried on flexible top plates that are fixed to and extend in cantilever fashion from base components of the holders. Such arrangements beneficially minimize the clearances that are the source of vibration and chattering problems. However, this advantage is partially offset by attendant compromises in blade conformability and uniformity of blade loading across the width of the surface being doctored, and a diminished ability to accommodate cross machine thermal expansion and contraction of the top plate.

In still other known doctoring arrangements of the type disclosed in U.S. Pat. No. 6,786,999 (Goodnow et al.), the doctor blade and top plate assembly is held in a clamp-type pivot or hinge along the back edge of the top plate. Loading and unloading tubes are disposed in compartments beneath the top plate. The loading tube is inflated and the unloading tube is deflated to pivot the assembly toward and thereby urge the doctor blade against the work surface. The inflation and deflation is reversed to pivot the assembly away from the work surface. Clamp-type hinges are composed of multiple separate components and achieve angular displacement by a frictional sliding between its relative parts.

### SUMMARY OF THE INVENTION

An objective of the present invention includes the provision of an improved doctoring apparatus that provides an angular motion capability using a one-piece flexible hinge, that eliminates sliding friction losses within the hinge, that provides impact resistance, shock absorption, and vibration dampening, and that maintains a liquid-tight seal along the length of and between the top plate and a doctor back.

An additional objective of the present invention is to provide an alternative to reverse assembled stainless steel leaf and pin style hinges. The hinge should have a rotational capacity of ±6.5° of rotational motion, be able to operate at temperatures of up to about 200° F., more preferably be able to operate at temperatures of up to about 450° F., and be subject to typical paper machine conditions, including exposure to water and dilute chemicals.

In accordance an aspect of the present invention, a doctor blade holder has a top plate having a rear portion overlying a base structure and a front portion projecting forward from the base structure. Blade support members are carried by and cooperate with the front portion of the top plate to define forwardly open slots for receiving the doctor blade. A hinge is interposed between the rear portion of the top plate and the base structure. The hinge has a body portion defining a fulcrum about which the top plate pivots relative to the base structure, and has forwardly and rearwardly projecting integral flanges arranged respectively to underlie the top plate and overlie the base structure. The doctor blade holder has means for securing the forwardly projecting flange to the top plate and for securing the rearwardly projecting flange to the base structure.

The hinge may advantageously be molded or extruded from an elastomer, preferably from a high temperature elastomer, such as Viton, available from DuPont Dow Elastomers LLC of Wilmington, Del. The hinge may be reinforced, either internally or externally, by a fabric, a preferred example being Kevlar available from E. I. du Pont de Nemours and Company of Wilmington, Del. A core selected from the group consisting of extruded elastomer, fiberglass rod, stainless steel mesh, and stainless steel cable may be integrally incorporated into the molded or extruded hinge body. The hinge body may also be internally configured to define a chamber containing a pressurized fluid.

These and other features and objectives of the present invention will now be described in greater detail with reference to the accompanying drawings.

### BRIEF DESCRIPTION OF THE DRAWINGS

FIGS. 1 and 2 are side views of an apparatus in accordance with the present invention for doctoring a roll surface “S”.

FIGS. 3 and 4 are side views of the apparatus shown in a loaded and unloaded condition.

FIGS. 5-8 show examples of hinges that could be used in the apparatus.

FIG. 9 is a side view of an apparatus for doctoring a roll surface having another example of a hinge.

FIG. 10 is a side view of an apparatus for doctoring a roll surface having still another example of a hinge.

### DETAILED DESCRIPTION

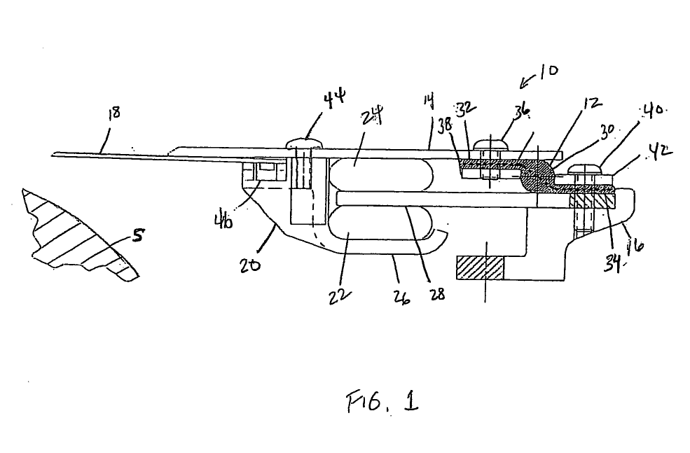

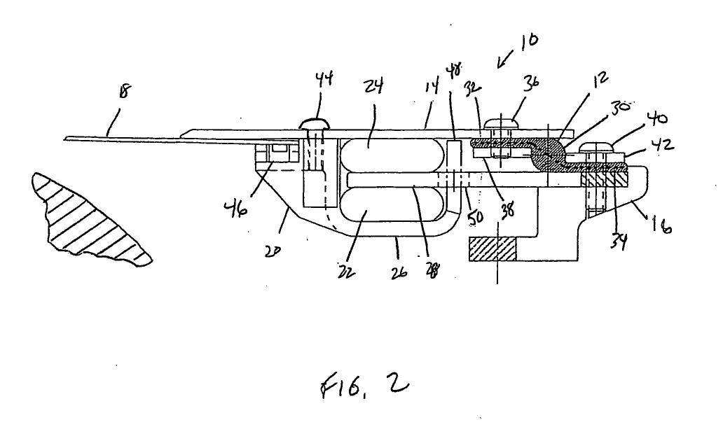

Referring to FIGS. 1 and 2, an apparatus 10 for doctoring a moving surface “S” is generally depicted. Apparatus 10 includes a hinge 12, described in more detail below, mounted between a top plate 14 and holder 16. A doctor blade 18 is held between the top plate 14 and a blade support member 20. A loading tube 22 is disposed between a first shelf 26, projecting rearwardly from blade support member 20, and a forwardly projecting second shelf 28 cantilevered from the holder 16. An unloading tube 24 is disposed between the second shelf 28 and top plate 14.

Hinge 12 has a continuous cylindrical body 30, an upper flange 32 integrally projecting forwardly from the upper half of body 30, and a lower flange 34 integrally projecting rearwardly from the lower half of body 30. Upper flange 32 is removably attached to top plate 14 with screws 36 and a fastening strip 38. Lower flange 34 is removably attached to holder 16 with screws 40 and a fastening strip 42. Alternatively, rivets could be used in place of screws 36 and 40 and either with or without fastening strips 38 and 42. Hinge 12 may be formed from many different materials to meet different applications. For example, hinge 12 may be molded or extruded from a high temperature elastomer, such as Viton, available from DuPont-Dow Chemicals.

Using a flexible material for hinge 12 has several advantages. First, it permits top plate 14 and, ultimately, doctor blade 18 to rotate about body 30 of hinge 12 while allowing hinge 12 to be a single, unitary element. Second, hinge 12 provides impact resistance and shock absorbance capacity to apparatus 10. Third, hinge 12 forms a seal between top plate 14 and holder 16 along the entire continuous length of hinge 12 that greatly reduces or eliminates the infiltration of contaminants.

Blade support member 20 is attached by screws 44 to the underside of the forwardly projecting portion of the top plate 14. The forward portions of the blade support members cooperate with the underside of the top plate to define forwardly open slots 46 configured and dimensioned to receive and retain the rear edge of doctor blade 18. A plurality of blade support members are used to retain doctor blade 18 and are spaced one from another along the cross-machine direction.

As shown in FIG. 2, certain blade support members may include a finger 48 projecting upwardly from first shelf 26 and through an opening 50 in second shelf 28. The fingers 48 retain loading tube 22 and unloading tube 24 in their respective positions between the first shelf 26, second shelf 28, and top plate 14. In one example, blade support members with fingers are spaced every 30 to 40 inches in the cross machine direction.

In operation, as shown in FIG. 3, the loading tube 22 is inflated and expanded with a corresponding deflation and collapse of unloading tube 24. This causes the top plate to rotate about body 30 of hinge 12 and thus urge the working edge of doctor blade 18 downwardly against roll surface “S”. The flexibility of hinge 12 permits a uniform and consistent loading between the doctor blade and the roll surface, irrespective of irregularities in the roll surface and gradual wear of the blade.

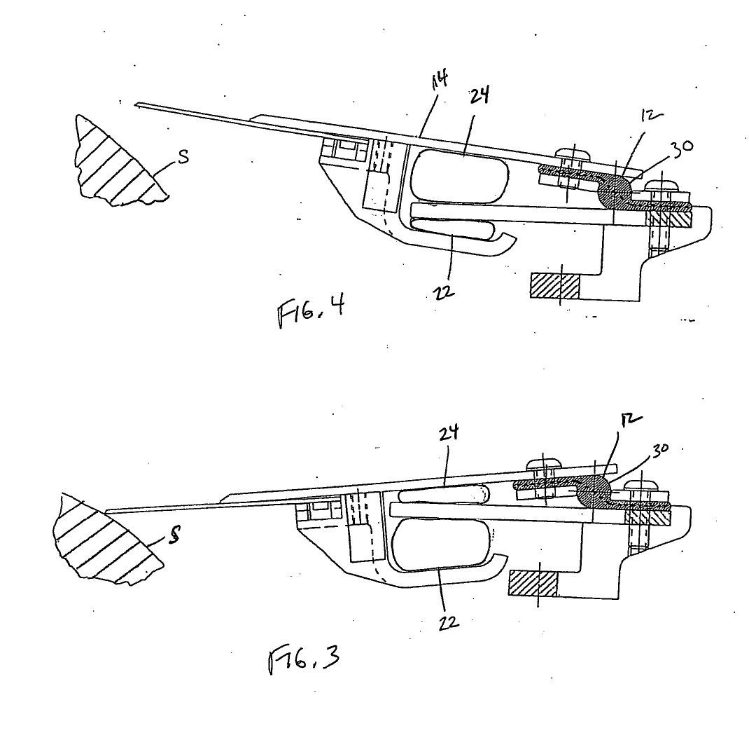

As shown in FIG. 4, the doctor blade 18 may be removed from the roll surface by simply deflating and collapsing loading tube 22 with a corresponding inflation and expansion of unloading tube 24.

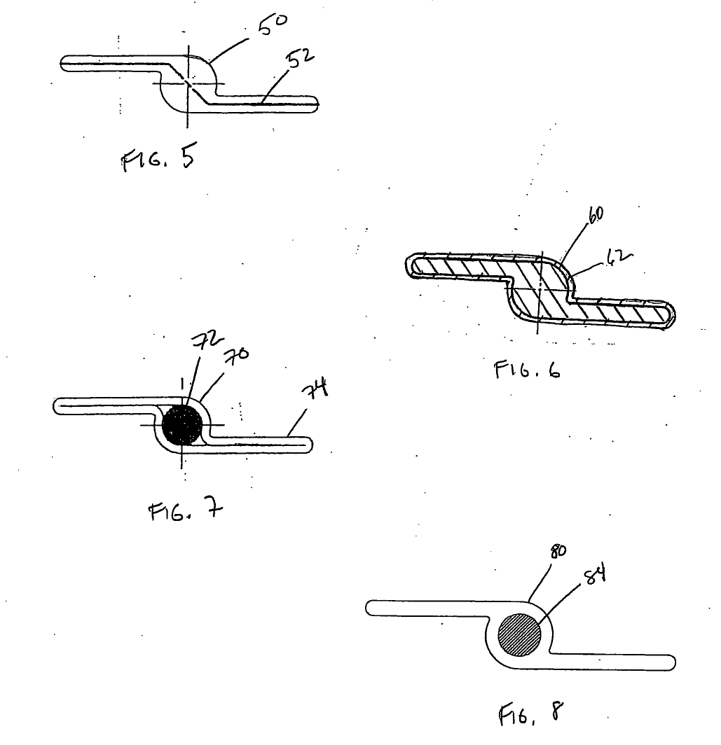

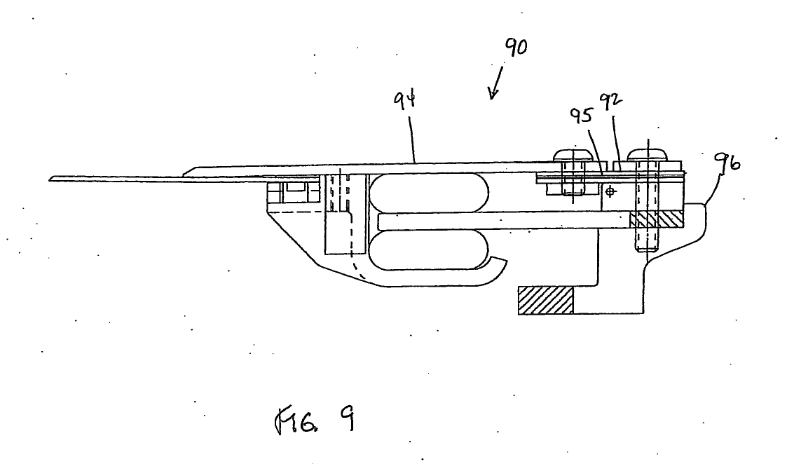

Referring to FIGS. 5-8, several examples of alternative hinge constructions are shown. As shown in FIG. 5, hinge 50 may be molded or extruded around a reinforcing fabric 52. The fabric, an example being Kevlar, increases the strength of the hinge and adds a factor of safety for long term durability. In another example, as shown in FIG. 6, a hinge 60 has a high temperature and high strength woven fabric 62 integrally bonded to its exterior surface. In another example shown in FIG. 7, hinge 70 has a core 72 around, which is an elastomer impregnated woven fabric outer jacket 74. The core could be an extruded or molded elastomer, a fiberglass rod, or a stainless steel mesh or cable. In an example shown in FIG. 8, hinge 80 includes a molded body 82 defining an internal chamber 84 that is filled with a liquid or a gas.

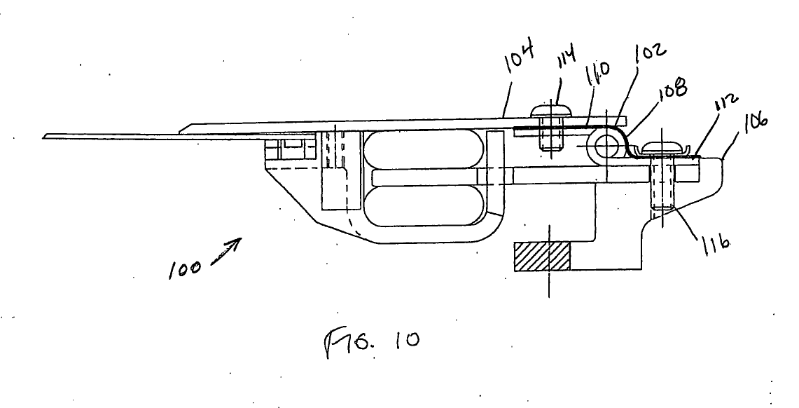

Referring to FIG. 9, another example of a flexible hinge is shown. Apparatus 90 has a planar hinge 92 mounted between top plate 94 and holder 96. Hinge 92 is a relatively flat strip of elastomeric material having an internal fabric reinforcement 95. Those skilled in the art will recognize that hinge 92 has many of the same advantages as the hinges described above, such as a unitary construction, flexibility, and the ability to form a seal for greatly reducing or eliminating the infiltration of contaminants between top plate 94 and holder 96.

Referring to FIG. 10, there may still be applications for which a roll doctoring apparatus 100 using a common so-called “leaf and pin” hinge 102 is desirable. For such applications a liquidic seal between top plate 104 and holder 106 can be created by installing a flexible elastomeric sealing strip 108 between upper leaf 110 and top plate 104 and secured to the top of lower leaf 112 by screws 114 and 116, respectively.

In light of the foregoing, it will now be appreciated by those skilled in the art that various changes may be made to the embodiment herein chosen for purposes of this disclosure without departing from the inventive concept defined by the following claims.

What is claimed is:

1. A doctor blade holder comprising:
a top plate having a rear portion overlying a base structure and a front portion projecting forward from the base structure;
blade support members carried by and cooperating with the front portion of the top plate to define forwardly open slots for receiving the doctor blade;
a hinge interposed between the rear portion of the top plate and the base structure, the hinge having a body portion defining a fulcrum about which the top plate pivots relative to the base structure, and having forwardly and rearwardly projecting integral flanges arranged respectively to underlie the top plate and overlie the base structure; and
means for securing the forwardly projecting flange to the top plate and for securing the rearwardly projecting flange to the base structure.

2. The doctor blade holder of claim 1, wherein the hinge is formed from an elastomer.

3. The doctor blade holder of claim 1, wherein the hinge is formed from a flourocarbon.

4. The doctor blade holder of claim 2, wherein the hinge is reinforced with a woven material.

5. The doctor blade holder of claim 4, wherein the woven material is encapsulated within the body portion and integral flanges.

6. The doctor blade holder of claim 4, wherein the woven material is bonded to a surface of the body portion and integral flanges.

7. The doctor blade holder of claim 4, wherein the woven material comprises an aramid fabric.

8. The doctor blade holder of claim 1, wherein the hinge forms a seal between top plate and base structure greatly reducing or eliminating the infiltration of contaminants therebetween.

9. The doctor blade holder of claim 1, wherein the hinge body portion includes a core selected from the group consisting of extruded elastomer, fiberglass rod, stainless steel mesh, and stainless steel cable.

10. The doctor blade holder of claim 1, wherein the hinge body portion defines a chamber filled with a pressurized liquid.

11. The doctor blade holder of claim 1 further comprising:
loading means for pivoting the top plate about the fulcrum and urging the doctor blade against a roll surface; and
unloading means for pivoting the top plate about the fulcrum and urging the doctor blade away from a roll surface.

12. The doctor blade holder of claim 11, wherein the base structure comprises a first shelf projecting forwardly from the fulcrum and the blade support members comprise rearwardly projecting second shelves.

13. The doctor blade holder of claim 12, wherein the loading means is disposed between the first shelf and the second shelves and comprises a first inflatable tube, and the unloading means is disposed between the top plate and the first shelf and comprises a second inflatable tube.

14. The doctor blade holder of claim 1, wherein means for securing the forwardly projecting hinge flange to the top plate and for securing the rearwardly projecting hinge flange to the base structure comprise screws or rivets.

15. A doctor blade holder comprising:
a top plate having a rear portion overlying a base structure and a front portion projecting forward from the base structure;
blade support members carried by and cooperating with the front portion of the top plate to define forwardly open slots for receiving the doctor blade;
a hinge interposed between the rear portion of the top plate and the base structure, the hinge having a body portion defining a fulcrum about which the top plate pivots relative to the base structure, and having forwardly and rearwardly projecting integral flanges arranged respectively to underlie the top plate and overlie the base structure;
loading means for pivoting the top plate about the fulcrum and urging the doctor blade against a roll surface; and
unloading means for pivoting the top plate about the fulcrum and urging the doctor blade away from a roll surface.

16. The doctor blade holder of claim 15, wherein the base structure comprises a first shelf projecting forwardly from the fulcrum and the blade support members comprise a rearwardly projecting second shelves.

17. The doctor blade holder of claim 16, wherein the loading means is disposed between the first shelf and the second shelves and comprises a first inflatable tube, and the unloading means is disposed between the top plate and the first shelf and comprises a second inflatable tube.

18. The doctor blade holder of claim 15, wherein the hinge is formed from an elastomer.

19. The doctor blade holder of claim 15, wherein the hinge is formed from a fluorocarbon.

20. The doctor blade holder of claim 18, wherein the hinge is reinforced with a woven material.

21. The doctor blade holder of claim 20, wherein the woven material is encapsulated within the body portion and integral flanges.

22. The doctor blade holder of claim 20, wherein the woven material is bonded to a surface of the body portion and integral flanges.

23. The doctor blade holder of claim 20, wherein the woven material comprises an aramid fabric.

24. The doctor blade holder of claim 15, wherein the hinge forms a seal between top plate and base structure.

25. The doctor blade holder of claim 15, wherein the hinge body portion includes a core chosen from the group of extruded elastomer, fiberglass rod, stainless steel mesh, and stainless steel cable.

26. The doctor blade holder of claim 15, wherein the hinge body portion comprises a chamber filled with a pressurized liquid.

27. The doctor blade holder of claim 15 further comprising means for securing the forwardly projecting hinge flange to the top plate and for securing the rearwardly projecting hinge flange to the base structure.

28. The doctor blade holder of claim 27, wherein means for securing the forwardly projecting hinge flange to the top plate and for securing the rearwardly projecting hinge flange to the base structure comprise screws or rivets.
